(19) United States
(12) Patent Application Publication
(10) Pub. No.: US 2013/0014440 A1
(43) Pub. Date: Jan. 17, 2013

(54) Systems, Methods, and Apparatus for Gasification

(71) Applicants: Richard DePuy, Schenectady, NY (US); Judeth Brannon Corry, Houston, TX (US)

(72) Inventors: Richard DePuy, Schenectady, NY (US); Judeth Brannon Corry, Houston, TX (US)

(73) Assignee: GENERAL ELECTRIC COMPANY, Schenectady, NY (US)

(21) Appl. No.: 13/184,165

(22) Filed: Jul. 15, 2011

(51) Int. Cl. B01F 3/04

(52) U.S. Cl. 48/180.1

(57) ABSTRACT

Certain embodiments of the invention may include systems, methods, and apparatus for gasification. According to an example embodiment of the invention, an apparatus can include a container operable to facilitate mixing a fuel and at least one gas inside the container. The apparatus can also include an inlet operable to receive the fuel and the at least one gas into the container, wherein an inlet flow path is defined by at least one trajectory of the fuel and the at least one gas entering the container. Further, the apparatus can include an outlet operable to permit a fuel-gas mixture to exit the container, wherein an outlet flow path is defined by an exit trajectory of the fuel-gas mixture exiting the container, wherein the inlet flow path not is aligned with the outlet flow path to facilitate increased operability for at least a portion of the fuel-gas mixture.

### FIELD OF THE INVENTION

This invention generally relates to gasification, and in particular to providing systems, processes, and apparatus for gasification.

### BACKGROUND OF THE INVENTION

Conventional gasification processes and systems use mixing containers or gasifiers to combine certain organic materials, such as carbon-based fuel, with an oxidant and an optional moderator. Example oxidants can include oxygen, air, or enriched air. Example moderators can include CO₂, water, or other gas to help keep temperatures from being excessive. In any instance, the combined materials result in syngas or synthetic gas, which can be used in a variety of industrial processes, stored, or otherwise, burned in a combustor, engine, or power plant.

FIG. 1 illustrates an example conventional gasifier system 100. The gasifier system 100 shown in FIG. 1 includes a reaction vessel 102, an inlet 104, and an outlet 106. Through the inlet 104 shown at near the upper portion of the reaction vessel 102, fuel 108 can be introduced with oxidant 110 and/or an optional moderator 112. When certain conditions are achieved within the reaction vessel 102, a gasification process can convert at least a portion of the mixture to a syngas 114. The syngas 114 can exit the reaction vessel 102 through the aligned outlet 106 shown in near the lower portion of the reaction vessel 102. The inlet 104 and outlet 106 are shown in direct correspondence or alignment with each other along line 116.

Certain conventional gasifier systems and processes are relatively inefficient. In some instances, a portion of the fuel 106 introduced into the system 100 may pass through the system without fully reacting with the oxidant 110 and/or optional moderator 112 within the system 100. In other instances, partially burned fuel, such as fine slag 114, may pass through the system 100 without fully reacting with the oxidant 110 and/or optional moderator 112 within the system 100. In both instances, the gasification process for some or all of the fuel 108 within the reaction vessel 102 may be incomplete.

### BRIEF SUMMARY OF THE INVENTION

Some or all of the above needs may be addressed by certain embodiments of the invention. Certain embodiments of the invention may include systems, methods, and apparatus for gasification. According to an example embodiment of the invention, an apparatus can be provided. The apparatus can include a container operable to facilitate mixing a fuel and at least one gas inside the container. The apparatus can also include an inlet operable to receive the fuel and the at least one gas into the container, wherein an inlet flow path is defined by at least one trajectory of the fuel and the at least one gas entering the container. Further, the apparatus can include an outlet operable to permit a fuel-gas mixture to exit the container, wherein an outlet flow path is defined by an exit trajectory of the fuel-gas mixture exiting the container, wherein the inlet flow path is not aligned with the outlet flow path to facilitate increased operability for at least a portion of the fuel-gas mixture.

According to another example embodiment, a method can be provided. The method can include providing a container operable to facilitate mixing of fuel and at least one gas inside the container. The method can also include providing an inlet operable to receive the at least one fuel and the at least one gas into the container, wherein an inlet flow path is defined by at least one trajectory of the at least one fuel and the at least one gas entering the container. Further, the method can include providing an outlet operable to permit a fuel-gas mixture to exit the container, wherein an outlet flow path is defined by an exit trajectory of the fuel-gas mixture exiting the container, wherein the inlet flow path is not in direct correspondence with the outlet flow path

According to another example embodiment, a system can be provided. The system can include a container operable to facilitate mixing a fuel and at least one gas inside the container. The system can also include an inlet operable to receive the fuel and the at least one gas into the container, wherein an inlet flow path is defined by at least one trajectory of the fuel and the at least one gas entering the container. Further, the system can include an outlet operable to permit a fuel-gas mixture to exit the container, wherein an outlet flow path is defined by an exit trajectory of the fuel-gas mixture exiting the container, wherein the inlet flow path is not in direct correspondence with the outlet flow path, wherein increased operability is facilitated for at least a portion of the fuel-gas mixture. The system can also include a combustor operable to receive the fuel-gas mixture.

Other embodiments, features, and aspects of the invention are described in detail herein and are considered a part of the claimed inventions. Other embodiments, features, and aspects can be understood with reference to the following detailed description, accompanying drawings, and claims.

### BRIEF DESCRIPTION OF THE FIGURES

Reference will now be made to the accompanying tables and drawings, which are not necessarily drawn to scale, and wherein:

FIG. 1 is a diagram of a conventional gasifier system.

FIG. 2 is an example system and apparatus according to an example embodiment of the invention.

FIG. 3 is another example system and apparatus according to an example embodiment of the invention.

FIG. 4 is a flow diagram of an example method according to an example embodiment of the invention.

### DETAILED DESCRIPTION OF THE INVENTION

Embodiments of the invention will be described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

Example embodiments of the invention may provide improved gasification and operability of gasifier systems, methods, and apparatus. Certain technical effects or solutions can be accomplished by one or more embodiments including improved gasifier and/or fuel-gas mixture operability during any number of events, such as startup, shutdown, turndown, transient-type events, and steady-state events. Further, one or more embodiments may provide the technical effect or solution of improving the conversion of certain fuels and materials to syngas. Ultimately, by increasing operability of the gasifier and/or a fuel-gas mixture, users such as power plant operators may have increased flexibility to operate the power plant and/or gasifier. For example, increased conversion of fuel and/or materials to syngas may permit a power plant operator may have a greater range of control system parameters, such as air and/or fuel flow rates, to work with.

Example embodiments of the invention will now be described with reference to the accompanying figures.

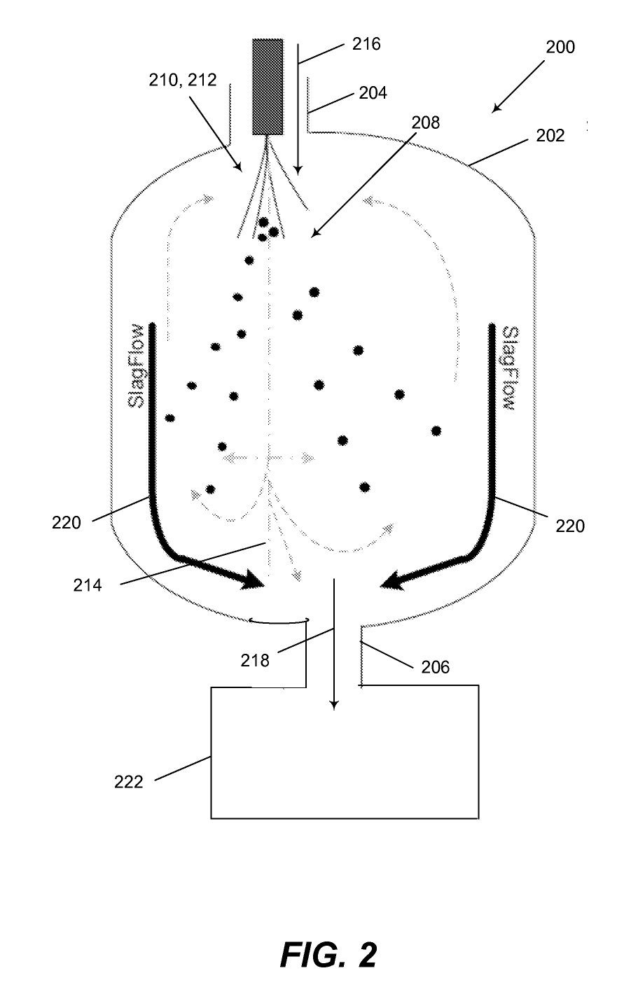

FIG. 2 illustrates an example system and apparatus according to an embodiment of the invention. As shown in FIG. 2, an example system and apparatus, such as gasifier 200, can include a container 202 with an inlet 204 and an outlet 206. Generally, the container 202 can be a vessel, chamber, or other mixing device used to contain at least one fuel, such as 208, or material and one or more gases 210, such as oxidant and/or optional moderator. The inlet 204, oriented adjacent to one portion of the container 202, can be operable to receive a fuel 208 or material and at least one gas 210 into the container 202. The outlet 206, oriented adjacent to another portion or opposing portion of the container 202, can be operable to permit a fuel-gas mixture 212 to exit the container 202. One suitable shape for a container, such as 202, can be a generally cylindrical-shaped vessel with a relatively smaller cylindrical-shaped inlet pipe and cylindrical-shaped outlet pipe on opposing ends of the vessel.

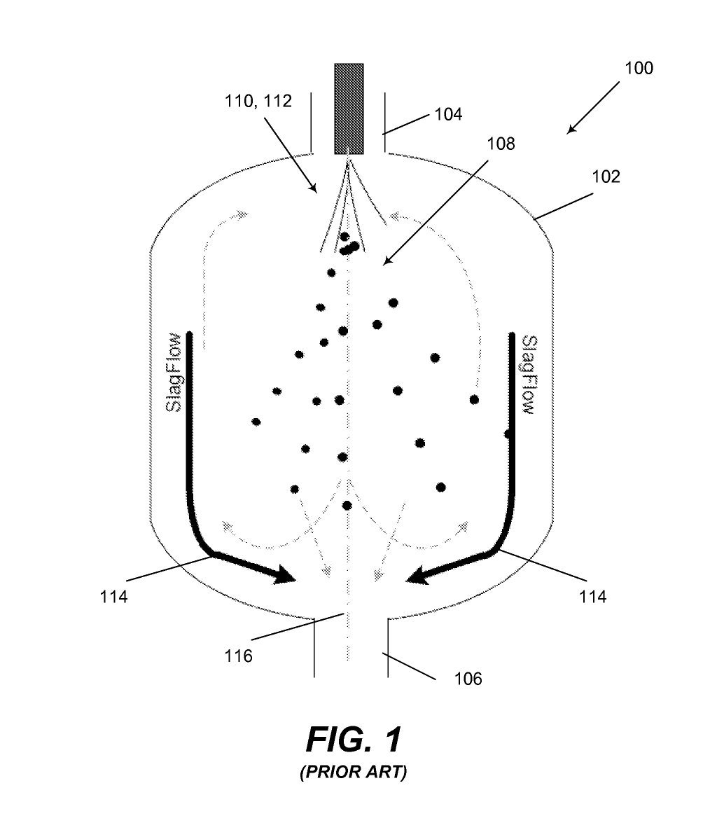

When fuel or material and the at least one gas are introduced into the container 202 via the inlet 204, an inlet flow path 214 can be defined by at least one trajectory 216 of the fuel or material and the at least one gas entering the container 202. As shown in FIG. 2, a fuel 208 and at least one gas 210, such as oxidant, are introduced into the container 202 along an inlet flow path 214 generally parallel with the orientation of the inlet 204 with respect to the container 202. Furthermore, an outlet flow path 218 can be defined by an exit trajectory of the fuel-gas mixture 212 exiting the container 202. In the example shown in FIG. 2, the inlet flow path 214 is not in direct correspondence or otherwise aligned with the outlet flow path 218. Since FIG. 2 shows the container 202 in one plane, the alignment of the inlet flow path 214 and outlet flow path 218 would be similar in all other planes, that is, the inlet flow path 214 and outlet flow path 218 would not be in direct correspondence with each other. In contrast, an example inlet flow path and outlet flow path in direct correspondence with each other are shown along line 116 in the conventional gasifier system 100 of FIG. 1.

In one aspect of an embodiment, an inlet flow path can be angled with respect to an outlet flow path. In another aspect of an embodiment, an inlet flow path can be offset from the outlet flow path.

In one aspect of an embodiment, an outlet can include at least one of the following: a refractory, a coating, a substance operable to minimize impact slag flow, a baffle, a quenching device, or a cooling device.

In any instance, the configuration of the container 202, inlet 204, and outlet 206 can lead to improved operability of the gasifier 200 and/or fuel-gas mixture 212. As the fuel 208 or material and one or more gases 210 circulate within the container 202, the fuel 208 or material can undergo a gasification process, which converts the fuel 208 or material to a syngas, or a fuel-gas mixture 212. Certain circulation characteristics within the container 202 may result from the configuration of the inlet 204 and outlet 206, wherein the gasification process may be enhanced. In certain instances, some or all of the partially burned fuel or material or other combustion by-products, also known as fine slag 220, may circulate within the container 202, and may ultimately convert to a syngas or fuel-gas mixture 212, or may exit the container 202 via the outlet 206. In any instance, the syngas or fuel-gas mixture 212 may be communicated from the outlet 206 to a downstream component, such as 222, where the syngas or fuel-gas mixture 212 may be utilized, stored, or burned to generate heat and/or power for a power generation component and/or turbine. In certain instances, a downstream component can include an industrial process to utilize a syngas or fuel-gas mixture, such as 212. For example, an industrial process can include, but is not limited to, a chemical manufacturing process, a hydrogen gas separation process, an ammonia production process, and a plastics manufacturing process.

In certain embodiments, a gasifier, such as 200, may provide increased operability for the conversion of a fuel or material to a syngas. Generally, increased operability may be measured or otherwise evaluated by the amount of syngas produced, rate of syngas production, less slag or unburned fuel or material exiting the gasifier, or decreased fuel, material, or other energy needed to produce a specified amount of syngas. In other embodiments, increased operability may be attained during any number of operating events, such as startup, shutdown, turndown, transient-type events, and steady-state events.

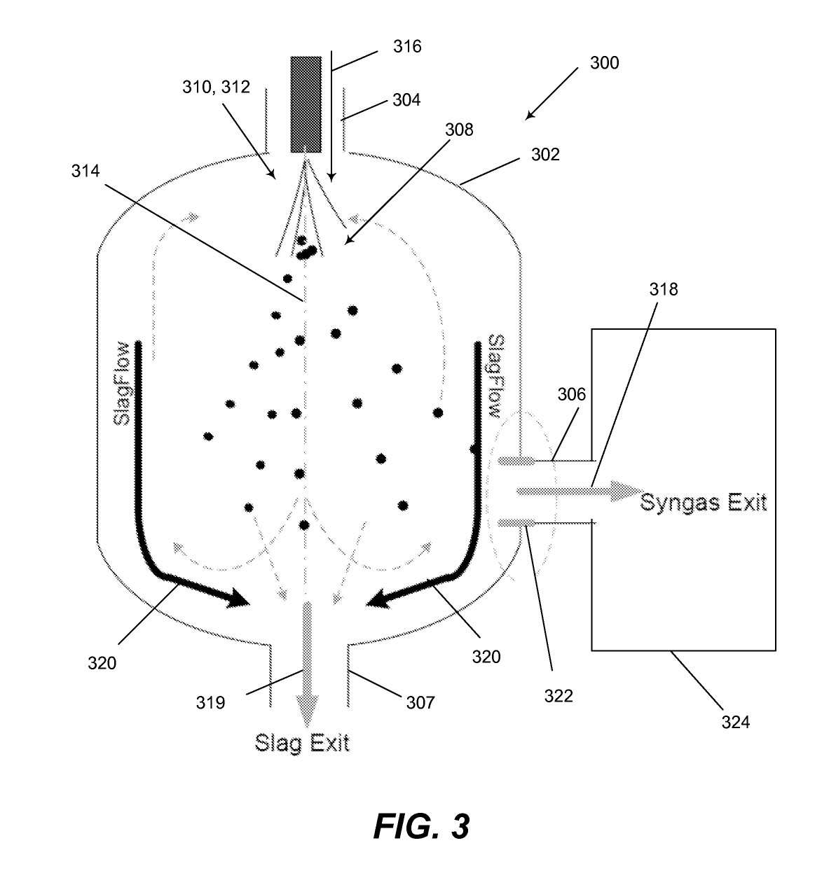

FIG. 3 illustrates another example system and apparatus according to an embodiment of the invention. As shown in FIG. 3, an example system and apparatus, such as gasifier 300, can include a container 302 with an inlet 304, a first outlet 306, and a second outlet 307. Generally, the container 302 can be a vessel, chamber, or other mixing device used to contain at least one fuel, such as 308, or material and one or more gases 310, such as oxidant and/or optional moderator. The inlet 304, oriented adjacent to one portion of the container 302, can be operable to receive a fuel 308 or material and at least one gas 310 into the container 302. The first outlet 306, oriented adjacent to another portion or lateral portion of the container 202, can be operable to permit a fuel-gas mixture 312 to exit the container 302. The second outlet 307, oriented adjacent to another portion or opposing portion of the container 302, can be operable to permit any unburned fuel or material or other by-products to exit the container 302. One suitable shape for a container, such as 302, can be a generally cylindrical-shaped vessel with a relatively smaller cylindrical-shaped inlet pipe on one end of the vessel, a cylindrical-shaped first outlet pipe on a lateral side of the vessel, and a cylindrical-shaped second outlet pipe on an opposing end of the vessel.

When fuel or material and the at least one gas are introduced into the container 302 via the inlet 304, an inlet flow path 314 can be defined by at least one trajectory 316 of the fuel or material and the at least one gas entering the container 302. As shown in FIG. 2, a fuel 308 and at least one gas 310, such as oxidant, are introduced into the container 302 along an inlet flow path 314 generally parallel with the orientation of the inlet 304 with respect to the container 302. Furthermore, a first outlet flow path 318 can be defined by an exit trajectory of the fuel-gas mixture 312 exiting the container 302. Also, a second outlet flow path 319 can be defined by an exit trajectory of any unburned fuel or material or other by-products, such as slag 320, exiting the container 302. In the example shown in FIG. 2, the inlet flow path 314 is not in direct correspondence or otherwise aligned with the outlet flow path 318. Since FIG. 3 shows the container 302 in one plane, the alignment of the inlet flow path 314 and outlet flow path 318, would be similar in all other planes, that is, the inlet flow path 314 and outlet flow path 318 would not be in direct correspondence with each other. In contrast, and as mentioned above, an example inlet flow path and outlet flow path in direct correspondence with each other are shown along line 116 in the conventional gasifier system 100 of FIG. 1.

In one embodiment, an inlet flow path may not be in direct correspondence or otherwise aligned with a second outlet flow path. For example, a second outlet 307 could be positioned on an opposing lateral wall of the container 302, opposite of the first outlet 306, wherein the inlet flow path would not be in direct correspondence with the second flow path.

In one aspect of an embodiment, an inlet flow path can be angled with respect to a first outlet flow path and a second outlet flow path. In another aspect of an embodiment, an inlet flow path can be offset from either or both the first outlet flow path and second outlet flow path.

In one aspect of an embodiment, an outlet can include at least one of the following: a refractory, a coating, a substance operable to minimize impact slag flow, a baffle, a quenching device, or a cooling device. An example refractory, a coating, a substance operable to minimize impact slag flow, a baffle, a quenching device, or a cooling device is shown in FIG. 3 at 322 positioned with respect to outlet 306.

In one aspect of an embodiment, an outlet can include a first outlet and a second outlet, the first outlet operable to permit a portion of the fuel-gas mixture to exit the container, and the second outlet operable to permit another portion of the fuel-gas mixture to exit the container, and wherein the respective outlet flow paths are defined by respective trajectories of the fuel-gas mixtures exiting the container, and wherein the inlet flow path is non-aligned with both outlet flow paths.

In any instance, the configuration of the container 302, inlet 304, first outlet 306, and second outlet 307 can lead to improved operability of the gasifier 300 and/or fuel-gas mixture 312. As the fuel 308 or material and one or more gases 310 circulate within the container 302, the fuel 308 or material can undergo a gasification process, which converts the fuel 308 or material to a syngas, or a fuel-gas mixture 312. Certain circulation characteristics within the container 302 may result from the configuration of the inlet 304, first outlet 306, and second outlet 307, wherein the gasification process and/or operability may be enhanced. In certain instances, some or all of the partially burned fuel or material or other combustion by-products may circulate within the container 302, and may ultimately convert to a syngas or fuel-gas mixture 312 and exit the container via the first outlet 306. In any instance, the syngas or fuel-gas mixture 312 may be communicated from the first outlet 306 to a downstream component, such as 324, where the syngas or fuel-gas mixture 312 may be utilized, stored, or burned to generate heat and/or power for a power generation component and/or turbine. In certain instances, a downstream component can include an industrial process to utilize a syngas or fuel-gas mixture, such as 312. For example, an industrial process can include, but is not limited to, a chemical manufacturing process, a hydrogen gas separation process, an ammonia production process, and a plastics manufacturing process.

In certain embodiments, a gasifier, such as 300, may provide increased operability for the conversion of a fuel or material to a syngas. Generally, increased operability may be measured or otherwise evaluated by the amount of syngas produced, rate of syngas production, less slag or unburned fuel or material exiting the gasifier, or decreased fuel, material, or other energy needed to produce a specified amount of syngas. In other embodiments, increased operability may be attained during any number of operating events, such as startup, shutdown, turndown, transient-type events, and steady-state events.

In example embodiments of the invention, the gasifier systems 200, 300 of FIGS. 2 and 3 may include any number of components operable facilitate any of the above described operations.

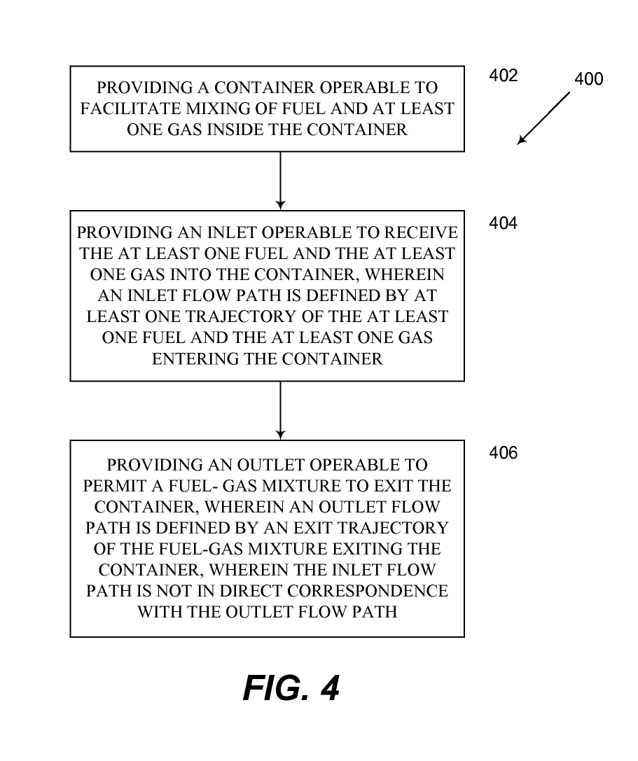

An example method 400 for providing a gasifier system will now be described with reference to the flowchart of FIG. 4. The example method 400 can be implemented by the gasifier systems and components shown in FIGS. 2 and 3. The method 400 starts in block 402, and according to an example embodiment of the invention, includes providing a container operable to facilitate mixing of fuel and at least one gas inside the container. In block 404, the method 400 includes providing an inlet operable to receive the at least one fuel and the at least one gas into the container, wherein an inlet flow path is defined by at least one trajectory of the at least one fuel and the at least one gas entering the container. In block 406, the method includes providing an outlet operable to permit a fuel-gas mixture to exit the container, wherein an outlet flow path is defined by an exit trajectory of the fuel-gas mixture exiting the container, wherein the inlet flow path is not in direct correspondence with the outlet flow path. The method 400 ends after block 406.

In example embodiments of the invention, the method 400 can include fewer or greater numbers of operations.

While certain embodiments of the invention have been described in connection with what is presently considered to be the most practical and various embodiments, it is to be understood that the invention is not to be limited to the disclosed embodiments, but on the contrary, is intended to cover various modifications and equivalent arrangements included within the scope of the appended claims. Although specific terms are employed herein, they are used in a generic and descriptive sense only and not for purposes of limitation.

This written description uses examples to disclose certain embodiments of the invention, including the best mode, and also to enable any person skilled in the art to practice certain embodiments of the invention, including making and using any devices or systems and performing any incorporated methods. The patentable scope of certain embodiments of the invention is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. An apparatus comprising:
a container operable to facilitate mixing a fuel and at least one gas inside the container;
an inlet operable to receive the fuel and the at least one gas into the container, wherein an inlet flow path is defined by at least one trajectory of the fuel and the at least one gas entering the container; and
an outlet operable to permit a fuel-gas mixture to exit the container, wherein an outlet flow path is defined by an exit trajectory of the fuel-gas mixture exiting the container, wherein the inlet flow path is not aligned with the outlet flow path to facilitate increased operability for at least a portion of the fuel-gas mixture.

2. The apparatus of claim 1, wherein the inlet flow path is angled with respect to the outlet flow path.

3. The apparatus of claim 1, wherein the inlet flow path is offset from the outlet flow path.

4. The apparatus of claim 1, wherein the outlet comprises a first outlet and a second outlet, the first outlet operable to permit a portion of the fuel-gas mixture to exit the container, and the second outlet operable to permit another portion of the fuel-gas mixture to exit the container, and wherein the respective outlet flow paths are defined by respective trajectories of the fuel-gas mixtures exiting the container, and wherein the inlet flow path is non-aligned with either or both outlet flow paths.

5. The apparatus of claim 1, wherein the increased operability improves conversion of the fuel to a syngas.

6. The apparatus of claim 1, wherein the outlet comprises at least one of the following: a refractory, a coating, a substance operable to minimize impact slag flow, a baffle, a quenching device, or a cooling device.

7. A method comprising:
providing a container operable to facilitate mixing of fuel and at least one gas inside the container;
providing an inlet operable to receive the at least one fuel and the at least one gas into the container, wherein an inlet flow path is defined by at least one trajectory of the at least one fuel and the at least one gas entering the container;
providing an outlet operable to permit a fuel-gas mixture to exit the container, wherein an outlet flow path is defined by an exit trajectory of the fuel-gas mixture exiting the container, wherein the inlet flow path is not in direct correspondence with the outlet flow path.

8. The method of claim 7, wherein the inlet flow path is angled with respect to the outlet flow path.

9. The method of claim 7, wherein the inlet flow path is offset from the outlet flow path.

10. The method of claim 7, wherein the outlet comprises a first outlet and a second outlet, the first outlet operable to permit a portion of the fuel-gas mixture to exit the container, and the second outlet operable to permit another portion of the fuel-gas mixture to exit the container, and wherein the respective outlet flow paths are defined by respective trajectories of the fuel-gas mixtures exiting the container, and wherein the inlet flow path is non-aligned with either or both outlet flow paths.

11. The method of claim 7, wherein the increased operability improves conversion of the fuel to a syngas.

12. The method of claim 7, wherein the outlet comprises at least one of the following:
a refractory, a coating, a substance operable to minimize impact slag flow, a baffle, a quenching device, or a cooling device.

13. A system comprising:
a container operable to facilitate mixing a fuel and at least one gas inside the container;
an inlet operable to receive the fuel and the at least one gas into the container, wherein an inlet flow path is defined by at least one trajectory of the fuel and the at least one gas entering the container;
an outlet operable to permit a fuel-gas mixture to exit the container, wherein an outlet flow path is defined by an exit trajectory of the fuel-gas mixture exiting the container, wherein the inlet flow path is not in direct correspondence with the outlet flow path, wherein increased operability is facilitated for at least a portion of the fuel-gas mixture; and
a downstream component operable to receive the fuel-gas mixture.

14. The system of claim 13, wherein the inlet flow path is angled with respect to the outlet flow path.

15. The system of claim 13, wherein the inlet flow path is offset from the outlet flow path.

16. The system of claim 13, wherein the outlet comprises a first outlet and a second outlet, the first outlet operable to permit a portion of the fuel-gas mixture to exit the container, and the second outlet operable to permit another portion of the fuel-gas mixture to exit the container, and wherein the respective outlet flow paths are defined by respective trajectories of the fuel-gas mixtures exiting the container, and wherein the inlet flow path is non-aligned with either or both outlet flow paths.

17. The system of claim 13, wherein the increased operability improves conversion of the fuel to a syngas.

18. The system of claim 13, wherein the outlet comprises at least one of the following:
a refractory, a coating, a substance operable to minimize impact slag flow, a baffle, a quenching device, or a cooling device.

19. The system of claim 13, wherein the downstream component comprises a gas turbine.

20. The system of claim 13, wherein the downstream component comprises an industrial process to utilize a portion of the fuel-gas mixture.
